(19) United States
(12) Patent Application Publication
(10) Pub. No.: US 2021/0239107 A1
(43) Pub. Date: Aug. 5, 2021

(54) ELASTIC DIAPHRAGM PUMP

(71) Applicant: DONGGUAN MINGCHUANGYOUSHANG ELECTRONIC TECHNOLOGY CO., LTD, DONGGUAN (CN)

(72) Inventor: WENTING ZHA, CHIZHOU CITY (CN)

(21) Appl. No.: 17/239,746

(22) Filed: Apr. 26, 2021

Related U.S. Application Data
(63) Continuation-in-part of application No. PCT/CN2018/122364, filed on Dec. 20, 2018.

(30) Foreign Application Priority Data
Oct. 27, 2018 (CN) 201821750847.1

(51) Int. Cl. F04B 43/04; F04B 49/24; F04B 49/12

(52) U.S. Cl. CPC F04B 43/04; F04B 49/125; F04B 49/24

(57) ABSTRACT

An elastic diaphragm pump comprises a fixed housing. A motor is fixedly connected to a bottom portion of the fixed housing. An end of an output shaft of the motor extends into the fixed housing, and is fixedly connected to a gear. A central shaft is rotatably connected between inner walls of the fixed housing. A transmission gear and an eccentric wheel are sequentially and rotatably connected to a surface of the central shaft. A pull rod is rotatably connected to a surface of the eccentric wheel. A lower fixing seat is fixedly connected to a top portion of the fixed housing. An elastic diaphragm is provided on a top portion of the lower fixing seat. A nut is fixedly connected to the center of the elastic diaphragm. An upper suction cover is provided on a top portion of the elastic diaphragm.

### CROSS-REFERENCE TO RELATED PATENT APPLICATION

This application is a Continuation-In-Part application of PCT Application Serial No. PCT/CN2018/122364, filed Dec. 20, 2018, which claims priority from CN Application No. 201821750847.1, filed Oct. 27, 2018, the entire contents of which are incorporated herein by reference in their entirety.

### FIELD OF THE DISCLOSURE

The present disclosure relates to the field of pump technologies, and more particularly, to an elastic diaphragm pump.

### BACKGROUND OF THE DISCLOSURE

Pumps on the market at present are roughly classified into centrifugal pumps and positive displacement pumps. The centrifugal pump cannot produce vacuum but can be used to pump water having a lot of impurities. The positive displacement pump can produce vacuum, but mechanical components of the pump are worn by impurities in the liquid during use, resulting in poor sealing performance, water leakage during use, and a short service life.

### SUMMARY OF THE DISCLOSURE

### (1) Technical Problem to be Solved

In view of the shortcomings in the prior art, the present disclosure provides an elastic diaphragm pump, which resolves the issue in which mechanical components are worn by impurities in a liquid during use of the pump, resulting in poor sealing performance, water leakage during use, and a short service life.

### (2) Technical Solution

To achieve the foregoing objective, the present disclosure is implemented by using the following technical solution:

An elastic diaphragm pump includes a fixed housing, where a drive mechanism is fixedly connected to a bottom portion of the fixed housing, a lower fixing seat is fixedly connected to a top portion of the fixed housing, an elastic diaphragm is provided on a top portion of the lower fixing seat, the center of the elastic diaphragm is fixedly connected to a power output end of the drive mechanism, an adapter valve is provided on a top portion of the elastic diaphragm, and a water inlet check valve and a water outlet check valve are sequentially and fixedly connected to an inner portion of the adapter valve.

Preferably, the elastic diaphragm is a rubber diaphragm, a nut is fixedly connected to the center of the elastic diaphragm, and the elastic diaphragm and the nut are bonded by vulcanization.

Preferably, the drive mechanism includes a motor, a gear, a central shaft, a transmission gear, an eccentric wheel, and a pull rod, where the motor is fixedly connected to the bottom portion of the fixed housing; an end of an output shaft of the motor extends into the fixed housing, and is fixedly connected to the gear; the central shaft is rotatably connected between inner walls of the fixed housing; the transmission gear and the eccentric wheel are sequentially and rotatably connected to the surface of the central shaft; the pull rod is rotatably connected to the surface of the eccentric wheel; the lower fixing seat is fixedly connected to the top portion of the fixed housing, and the elastic diaphragm is provided on the top portion of the lower fixing seat; and a nut is fixedly connected to the center of the elastic diaphragm, and an end of the pull rod that is far away from the eccentric wheel is in threaded connection with the nut.

Preferably, the gear and the transmission gear are hypoid gears and are connected by engagement.

Preferably, the transmission gear and the eccentric wheel are integrally injection-molded, and the eccentric wheel has an eccentric distance of 1.3 mm.

Preferably, an upper suction cover is further provided on the top portion of the elastic diaphragm, and an end of the upper suction cover is fixedly connected to the adapter valve.

Preferably, an end of the adapter valve that is close to the water inlet check valve is a water inlet end, and an end of the adapter valve that is close to the water outlet check valve is a water outlet end.

### (3) Advantageous Effects

The present disclosure provides an elastic diaphragm pump, which has the following advantageous effects:

In the elastic diaphragm pump of the present invention, a motor is fixedly connected to a bottom portion of a fixed housing, an end of an output shaft of the motor extends into the fixed housing and is fixedly connected to a gear, a central shaft is rotatably connected between inner walls of the fixed housing, a transmission gear and an eccentric wheel are sequentially and rotatably connected to the surface of the central shaft, and a pull rod is rotatably connected to a surface of the eccentric wheel. By means of meshing drive with the gears, the motor drives the eccentric wheel to rotate, thus driving the pull rod to move up and down. A lower fixing seat is fixedly connected to the top portion of the fixed housing, an elastic diaphragm is provided on the top portion of the lower fixing seat, and a nut is fixedly connected to the center of the elastic diaphragm. An end of the pull rod that is far away from the eccentric wheel is in threaded connection with the nut. A suction force is produced when the pull rod moves up and down to drive the elastic diaphragm to move up and down, and water supply is realized by using check valves, thus avoiding impurities in a liquid from wearing mechanical components and improving the sealing performance. Further, water leakage is avoided during use, thus prolonging the service life of the pump.

### BRIEF DESCRIPTION OF THE DRAWINGS

FIG. 1 is a schematic diagram of an overall structure of the present disclosure;

FIG. 2 is a schematic diagram of an internal structure of the present disclosure; and

FIG. 3 is cutaway view in A-A direction of FIG. 2 in the present disclosure.

Meanings of numerals: 1. Fixed housing, 2. Motor, 3. Gear, 4. Central shaft, 5. Transmission gear, 6. Eccentric wheel, 7. Pull rod, 8. Lower fixing seat, 9. Elastic diaphragm, 10. Nut, 11. Upper suction cover, 12. Adapter valve, 13. Water inlet check valve, and 14. Water outlet check valve

### DETAILED DESCRIPTION OF THE EXEMPLARY EMBODIMENTS

The technical solutions in the embodiments of the present disclosure are clearly and completely described below with reference to the accompanying drawings in the embodiments of the present disclosure. Apparently, the described embodiments are some rather than all of the embodiments of the present disclosure. Based on the described embodiments of the present disclosure, other embodiments acquired by those of ordinary skill in the art without creative effort all belong to the protection scope of the present disclosure.

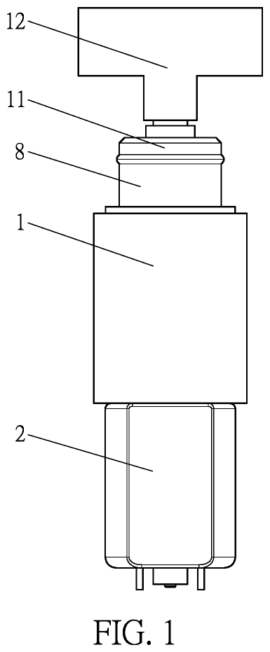

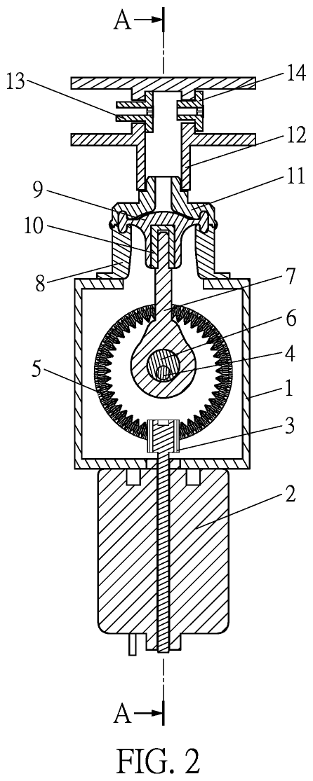

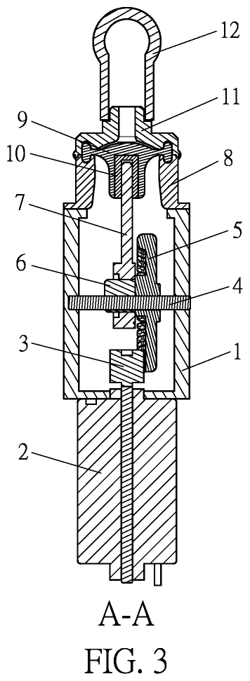

Referring to FIGS. 1 to 3, the present disclosure provides the following technical solution: An elastic diaphragm pump includes a fixed housing 1. A drive mechanism is fixedly connected to a bottom portion of the fixed housing 1, a lower fixing seat 8 is fixedly connected to a top portion of the fixed housing 1, an elastic diaphragm 9 is provided on a top portion of the lower fixing seat 8, and the center of the elastic diaphragm 9 is fixedly connected to a power output end of the drive mechanism. An adapter valve 12 is provided on a top portion of the elastic diaphragm 9, and a water inlet check valve 13 and a water outlet check valve 14 are sequentially and fixedly connected to an inner portion of the adapter valve 12.

The drive mechanism includes a motor 2, a gear 3, a central shaft 4, a transmission gear 5, an eccentric wheel 6, and a pull rod 7. Specifically, the motor 2 is fixedly connected to the bottom portion of the fixed housing 1. An end of an output shaft of the motor 2 extends into the fixed housing 1, and is fixedly connected to the gear 3. The central shaft 4 is rotatably connected between inner walls of the fixed housing 1. The transmission gear 5 and the eccentric wheel 6 are sequentially and rotatably connected to the surface of the central shaft 4. The pull rod 7 is rotatably connected to the surface of the eccentric wheel 6, and the eccentric wheel 6 can drive the pull rod 7 to move up and down. The lower fixing seat 8 is fixedly connected to the top portion of the fixed housing 1, the elastic diaphragm 9 is provided on the top portion of the lower fixing seat 8, and a nut 10 is fixedly connected to the center of the elastic diaphragm 9. An end of the pull rod 7 that is far away from the eccentric wheel 6 is in threaded connection with the nut 10, and a suction force can be produced when the pull rod 7 drives the elastic diaphragm 9 to move. An upper suction cover 11 is provided on the top portion of the elastic diaphragm 9, and the adapter valve 12 is fixedly connected to an end of the upper suction cover 11. The water inlet check valve 13 and the water outlet check valve 14 are sequentially and fixedly connected to an inner portion of the adapter valve 12. When the elastic diaphragm 9 moves downwards, the water inlet check valve 13 is opened by suction to let water in, while the water outlet check valve 14 is sucked tightly to block off a water outlet direction. When the elastic diaphragm 9 moves upwards, the water inlet check valve 13 is automatically closed and water pushes the water outlet check valve 14 open in this case, thus discharging the water.

The gear 3 and the transmission gear 5 are hypoid gears and are connected by engagement, so as to enable the motor 2 to drive the transmission gear 5 to move.

The transmission gear 5 and the eccentric wheel 6 are integrally injection-molded. The eccentric wheel 6 has an eccentric distance of 1.3 mm, so that it can drive the pull rod 7 to move up and down.

An end of the adapter valve 12 that is close to the water inlet check valve 13 is a water inlet end, and an end of the adapter valve 12 that is close to the water outlet check valve 14 is a water outlet end.

The elastic diaphragm 9 is a rubber diaphragm, and the elastic diaphragm 9 and the nut 10 are bonded by vulcanization.

During use, the motor 2 drives the eccentric wheel 6 to rotate by means of gear drive, and the eccentric wheel 6 drives the pull rod 7 to move up and down during rotation, thus driving the elastic diaphragm 9 to move up and down. When the elastic diaphragm 9 moves downwards, the water inlet check valve 13 is opened by suction to let water in, while the water outlet check valve 14 is sucked tightly to block off a water outlet direction. When the elastic diaphragm 9 moves upwards, the water inlet check valve 13 is automatically closed and water pushes the water outlet check valve 14 open in this case, thus discharging the water.

It should be noted that, in this specification, relationship terms such as “first”, “second”, etc. are used only to distinguish one entity or operation from another, and do not necessarily require or imply any such actual relationship or order between those entities or operations. Moreover, the term “include”, “comprise” or any other variations thereof are intended to cover non-exclusive inclusion, so that a process, method, commodity or device including a series of elements not only includes these elements, but also includes other elements not explicitly listed, or further includes inherent elements of the process, method, commodity or device. In a case without any more limitations, an element defined by “including a(n) . . . ” does not exclude that the process, method, commodity or device including the elements further has other identical elements.

Although the embodiments of the present disclosure have been shown and described above, those of ordinary skill in the art can make various changes, modifications, replacements, and transformations without departing from the principle and spirit of the present disclosure. The scope of the present disclosure is defined by the appended claims and their equivalents.

What is claimed is:

1. An elastic diaphragm pump, comprising a fixed housing (1), wherein a drive mechanism is fixedly connected to a bottom portion of the fixed housing (1), a lower fixing seat (8) is fixedly connected to a top portion of the fixed housing (1), an elastic diaphragm (9) is provided on a top portion of the lower fixing seat (8), a center of the elastic diaphragm (9) is fixedly connected to a power output end of the drive mechanism, an adapter valve (12) is provided on a top portion of the elastic diaphragm (9), and a water inlet check valve (13) and a water outlet check valve (14) are sequentially and fixedly connected to an inner portion of the adapter valve (12).

2. The elastic diaphragm pump according to claim 1, wherein the elastic diaphragm (9) is a rubber diaphragm, a nut (10) is fixedly connected to the center of the elastic diaphragm (9), and the elastic diaphragm (9) and the nut (10) are bonded by vulcanization.

3. The elastic diaphragm pump according to claim 1, wherein the drive mechanism comprises a motor (2), a gear (3), a central shaft (4), a transmission gear (5), an eccentric wheel (6), and a pull rod (7); the motor (2) is fixedly connected to the bottom portion of the fixed housing (1); an end of an output shaft of the motor (2) extends into the fixed housing (1), and is fixedly connected to the gear (3); the central shaft (4) is rotatably connected between inner walls of the fixed housing (1); the transmission gear (5) and the eccentric wheel (6) are sequentially and rotatably connected to a surface of the central shaft (4); the pull rod (7) is rotatably connected to a surface of the eccentric wheel (6); the lower fixing seat (8) is fixedly connected to the top portion of the fixed housing (1), and the elastic diaphragm (9) is provided on the top portion of the lower fixing seat (8); and a nut (10) is fixedly connected to the center of the elastic diaphragm (9), and an end of the pull rod (7) that is far away from the eccentric wheel (6) is in threaded connection with the nut (10).

4. The elastic diaphragm pump according to claim 3, wherein the gear (3) and the transmission gear (5) are hypoid gears and are connected by engagement.

5. The elastic diaphragm pump according to claim 4, wherein the transmission gear (5) and the eccentric wheel (6) are integrally injection-molded, and the eccentric wheel (6) has an eccentric distance of 1.3 mm.

6. The elastic diaphragm pump according to claim 1, wherein an upper suction cover (11) is further provided on the top portion of the elastic diaphragm (9), and an end of the upper suction cover (11) is fixedly connected to the adapter valve (12).

7. The elastic diaphragm pump according to claim 6, wherein an end of the adapter valve (12) that is adjacent to the water inlet check valve (13) is a water inlet end, and an end of the adapter valve (12) that is adjacent to the water outlet check valve (14) is a water outlet end.
